(19) United States
(12) Patent Application Publication
(10) Pub. No.: US 2022/0032392 A1
(43) Pub. Date: Feb. 3, 2022

(54) Method for Operating a Welding Device, and Welding Robot

(71) Applicant: Bayerische Motoren Werke Aktiengesellschaft, Muenchen (DE)

(72) Inventors: Thomas HAUNSTETTER, Muenchen (DE); Sebastian REICHENBACH, Muenchen (DE)

(21) Appl. No.: 17/279,480

(22) PCT Filed: Aug. 13, 2019
(86) PCT No.: PCT/EP2019/071713

§ 371 Date: Mar. 24, 2021

(51) Int. Cl. B23K 11/30; B23K 11/11; B25J 11/00; B25J 13/08; B25J 15/00

(52) U.S. Cl. CPC B23K 11/3063; B23K 11/115; B23K 11/3072; B25J 13/085; B25J 15/0019; B25J 11/005

(57) ABSTRACT

A method for operating a welding device for resistance welding includes carrying out a verification measurement by moving electrodes of the welding device toward one another and measuring a force in combination with measuring a distance between the electrodes. Electrode wear is ascertained by using the measured distance. The electrodes or component parts of the electrodes are changed or cleaned depending on the ascertained electrode wear.

### BACKGROUND AND SUMMARY OF THE INVENTION

The present invention relates to a method for operating a welding device for resistance welding, to a welding robot, to a computer program product and to a use of an electromechanical drive of a welding device.

Resistance welding, for example by means of welding robots or robot-guided welding guns, is a joining method that is typically used in automotive body making. The best possible quality and the shortest cycle times are required here. However, the welding electrodes thereby undergo continuous wear, which influences the quality of the joints. In order to be able to respond to this, DE 10 2016 211 684 A1 for example discloses a method for the resistance welding of workpieces of aluminum or aluminum alloys with a welding gun, wherein an assessment variable for characterizing the metal pickup on the electrodes is determined from a force profile of the electrodes during the welding. DE 10 2016 209 640 A1 discloses a method for calibrating a welding gun for resistance welding, wherein at least one measured value of at least one variable characterizing the welding process, such as for example an electrode force, is determined during the implementation of regular welding processes, in order then to decide in dependence on this measured value whether a calibration of the welding gun is possibly necessary. However, the approaches mentioned are relatively inaccurate and, for example, do not allow cleaning, in particular milling, of the electrode caps of the welding device in a way that is specifically selective and carried out as and when required.

Therefore, an object of the present invention is to provide a method for operating a welding device, a welding robot, a computer program product and a use of an electromechanical drive of a welding device that allow in particular electrode caps to be milled in a way that is based on quality, carried out as and when required and conserves resources.

### DETAILED DESCRIPTION OF THE INVENTION

According to the invention, a method for operating a welding device for resistance welding, in particular for resistance spot welding, comprises the steps of:
carrying out a verification measurement by moving the electrodes of a welding device, such as a welding gun, toward one another with a defined force in combination with a distance measurement;
using the distance measurement for ascertaining electrode wear;
depending on the electrode wear ascertained, changing or cleaning the electrodes or component parts thereof.

An exact force measurement in this case advantageously allows an exact distance measurement. By means of the “distance”, a position or a spacing of the electrodes, in particular the electrode caps, in relation to one another can be determined. This spacing may change as a result of dirt, contaminants and/or metal picked up. From this, it can be detected that cleaning or changing of the electrodes or the component parts thereof is possibly necessary, while it is also known as a result of the determination or evaluation of the distance in particular whether for example much material or little material has to be removed in the course of electrode cap milling.

According to a preferred embodiment, the welding device comprises an electromechanical drive, wherein the method comprises the step of:
using the drive for measuring the distance and force, in particular for the verification measurement.

Advantageously, therefore, no additional sensors or the like, which would first have to be laboriously applied and so on, are used. Instead, the drive of the welding gun itself is used to carry out the verification measurement. Advantageously, the welding device, comprising in particular a or the welding gun, has a servomotor with a, preferably internal, possibly piezoelectric, force transducer. For the distance measurement and positioning of the welding gun, advantageously a suitable resolver is used. A resolver is an electromagnetic measuring transducer for converting the angular position of a rotor into an electrical variable. Advantageously, a multipole resolver is used, in particular for example an eight-pole resolver.

The welding gun typically comprises two electrodes. Each of the electrodes in this case comprises an electrode shank and an electrode cap, which is for example arranged on the end of the electrode shank, or the electrode holder or else the electrode arm, for example is fitted on it.

According to one embodiment, the method comprises the step of:
ascertaining the electrode wear by comparing the measured value for the distance (from the verification measurement) with a corresponding base and/or reference value.

The method thereby advantageously allows both for example the detection of wear of the electrode shank and the determination and detection of wear of the electrode cap(s). Expediently, a number of comparison values, such as for example the aforementioned base value and the aforementioned reference value, are used for this.

According to one embodiment, the method comprises the step of:
carrying out a verification measurement after an electrode cap change to determine the base value for shank wear.

Over time, not only the electrode caps but also the shaft on which the electrode caps are arranged become worn. For example, they become shorter. As a result of the verification measurement after an electrode cap change or as a result of the comparison of successive base values, it can be advantageously determined to what extent for example an electrode shank has become shorter.

According to one embodiment, the method comprises the step of:
carrying out a verification measurement after cleaning of the electrode caps to determine the reference value for electrode cap wear.

The cleaning of the electrode caps comprises in particular a removal, in particular a mechanical removal, of material from the electrode caps, in order to clean them and in particular to free them of metal picked up or contaminants. Advantageously, this is not performed randomly, but as and when required and in a way conserving resources, since it can be monitored by the verification measurements for example how much has been mechanically removed.

Expediently, verification measurements are carried out in specific, predeterminable and possibly changeable time intervals. According to one embodiment, after a welding operation, the welding gun moves into a defined position and the verification measurement is started. The distance thereby ascertained is compared with the last reference value, with the current wear being inferred in this way. If the wear is within a definable, and preferably also adaptable, tolerance window, welding can be continued, otherwise cleaning, in particular milling, is performed.

Expediently, the method comprises the step of:
regulating the force in the verification measurement or in the verification measurements with an accuracy of +/−30 N, preferably of +/−20 N, or, if possible, with even smaller tolerances.

The aforementioned resolver that is used for the distance measurement and positioning of the welding gun may realize an accuracy of 50 μm in the installed state. Together with the highly accurate force measurement, these boundary conditions allow not only an extremely clean and reliable welding operation, but also the direct and immediate implementation of verification measurements, without the use of further or external measuring equipment.

As already mentioned, the verification measurement is preferably always carried out at or in the same position (of the welding guns), in order as far as possible not to influence the measurement. According to one embodiment, in the verification measurement the electrodes are repeatedly moved together or toward one another. The values thereby determined are advantageously averaged and/or used together for a plausibility check.

Preferably, the method also comprises the step of:
cleaning the electrode caps by milling.

According to one embodiment, the method comprises the steps of:
providing a cap miller and beginning the electrode cap milling with a defined milling force;
monitoring a removal of material by milling to adapt the milling force, a milling time and/or a milling interval.

The monitoring is in this case advantageously performed by means of a verification measurement after the milling operation. This verification measurement can be used to find out whether for example a certain amount of material to be removed by milling, which may for example lie in a range of 500 μm, has actually been removed. If this is not the case, for example, the milling force may be corrected upwardly or downwardly. At this point it should also be mentioned that the milling operation may be conducted in such a way that the welding gun moves with its electrode caps toward a milling tool and/or that a suitable milling tool is moved toward the electrode caps.

According to one embodiment, the method comprises the step of:
comparing the distance measurements of verification measurements before and after the cleaning to adapt the milling force, the milling time and/or the milling interval.

Advantageously, a dynamic adaptation of the parameters for the following milling cycle can take place if the amount of material removed by milling is outside a certain tolerance band. The parameters in this case comprise in particular the milling force, the milling time and/or the milling interval, that is to say the time interval between two milling cycles. If tolerance limits are exceeded, a warning, for example that a milling tool of the electrode cap miller must be changed because for example it has become worn, may also be issued.

The invention also relates to a welding robot, comprising a controller, which is designed to carry out the method according to the invention. Furthermore, the invention comprises a computer program product, which contains software with sections of software code that cause a computer to carry out the method according to the invention when the computer program product is run on the computer.

Furthermore, the invention comprises the use of an electromechanical drive of a welding device, in particular a welding gun, for monitoring electrode wear. Expediently, the electromechanical drive comprises a servomotor with an internal, and possibly piezoelectric, force transducer and a suitably formed resolver for distance measurement and positioning of the welding gun. Advantageously, a multipole resolver is used, in particular for example an eight-pole resolver. Alternative angular position encoders or angular encoders that can likewise be used are for example a potentiometric encoder, an incremental encoder and/or an absolute encoder. The aforementioned eight-pole resolver is however preferred in particular, because of the high accuracy that is achievable.

The advantages and features mentioned in connection with the method apply analogously and correspondingly to the welding robot, the computer program product and the use, and vice versa as well as in combination.

The provided method allows the electrodes to be changed and/or cleaned in a way that is based on quality, carried out as and when required and conserves resources, in particular allows the electrode caps to be milled in a way that conserves resources. This is advantageously performed on the basis of the mechanical reference variables force and distance of the welding gun, advantageously on-line or after corresponding presettable (milling) intervals. The reproducibility of the milling cycles and the electrode life within each milling cycle can be increased. Moreover, the electrode caps can be milled more often, since the removal of material is not performed randomly but in a way that is specifically selective and carried out as and when required, in particular also by means of the dynamic adaptation of the aforementioned parameters.

1.-12. (canceled)

13. A method for operating a welding device for resistance welding, comprising the steps of:
carrying out a verification measurement by moving electrodes of the welding device toward one another and measuring a force in combination with measuring a distance between the electrodes;
ascertaining electrode wear by using the measured distance; and
changing or cleaning the electrodes or component parts of the electrodes depending on the ascertained electrode wear.

14. The method according to claim 13, wherein the welding device includes an electromechanical drive and wherein the force and the distance are measured by the electromechanical drive.

15. The method according to claim 13, wherein the electrodes each comprise a respective electrode cap and an electrode shank.

16. The method according to claim 13, wherein the step of ascertaining the electrode wear further includes comparing the measured distance with a base value and/or a reference value.

17. The method according to claim 13, wherein the step of carrying out the verification measurement is performed after a change of a respective electrode cap of the electrodes to determine a base value for a wear of a respective shank of the electrodes.

18. The method according to claim 13, wherein the step of carrying out the verification measurement is performed after cleaning of a respective electrode cap of the electrodes to determine a reference value for a wear of the respective electrode cap.

19. The method according to claim 13 further comprising the step of regulating the force with an accuracy of +/−30 N.

20. The method according to claim 18, wherein the cleaning comprises the steps of:
providing a cap miller and beginning milling of the respective electrode cap by the cap miller with a milling force; and
monitoring a removal of material from the respective electrode cap by the milling to adapt the milling force, a milling time, and/or a milling interval.

21. The method according to claim 20 further comprising the steps of:
measuring a respective distance between the electrodes before and after the cleaning; and
comparing the respective distances to adapt the milling force, the milling time, and/or the milling interval.

22. A welding robot, comprising:
a controller configured to perform the method according to claim 13.

24. A method for using an electromechanical drive of a welding device, comprising the step of:
using the electromechanical drive of the welding device to monitor wear of electrodes of the welding device.

25. The method according to claim 24, wherein the welding device is a welding gun.
